(19) United States
(12) Patent Application Publication
(10) Pub. No.: US 2005/0050206 A1
(43) Pub. Date: Mar. 3, 2005

(54) Dialogue support system, device, method and program

(75) Inventors: Manabu Ueda, Kanagawa (JP); Yuichi Ueno, Kanagawa (JP); Motohisa Sodeyoshi, Kanagawa (JP); Masakazu Fujimoto, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/776,592

(22) Filed: Feb. 12, 2004

(30) Foreign Application Priority Data
Aug. 26, 2003 (JP) 2003-301303

(51) Int. Cl. G06F 15/16

(52) U.S. Cl. 709/227

(57) ABSTRACT

A dialogue support system for supporting the occurrence of a dialogue in a place designated as a dialogue place, which comprises a dialogue condition accumulation section for accumulating a dialogue condition containing the designation of a desired situation and the designation of a destination, a situation detection device, which is disposed in the dialogue place, for detecting a situation of the dialogue place, a situation monitoring section for comparing the situation of the dialogue place detected by the situation detection device and the dialogue condition accumulated in the dialogue condition accumulation section to judge whether the detected situation conforms to the dialogue condition, and a notification section for notifying a designated destination that the situation conforming to the dialogue condition has occurred when it is judged by the situation monitoring section that the situation conforms to the dialogue condition.

### BACKGROUND OF THE INVENTION

1. Field of the Invention

The present invention relates to a dialogue support system, device, method and program, and more particularly to a dialogue support system, device, method and program including reserving and notifying services, such as a service based on information on the presence of a person in a space for organizational activities, to give a notice about formation of a reservation made by a user.

2. Description of the Related Art

Conventionally, a dialogue in an organization was focused on the formal dialogue at a meeting or business talks. Therefore, as a technology capable of supporting dialogues, there have been proposed a variety of technologies for supporting an adjustment of meeting schedules, a remote meeting and a reservation for a conference room.

And, many systems are available to support a dialogue by supporting through the process of a dialogue, such as supporting a dialogue between different languages, supporting a remote dialogue by means of a common medium, and supporting a dialogue to support an idea by dividing the utterance during the dialogue into words by voice recognition and showing different words associated with such words.

Meanwhile, as a service using information on the position of a person in a prescribed place, there is a technology to support lost child information in a place where an indefinite number of people visit (e.g., Japanese Patent Application Laid-Open No. 04-311300).

There is also a technology such as a target position notification system which previously reserves place information and notifies an approach to the pertinent place (e.g., a notification of arrival at or approach to a previously designated station or stop) (e.g., Japanese Patent Application Laid-Open No. 2001-241964).

In addition, there is a technology of detecting individuals' whereabouts in a business place or the like to notify where they are and also detecting an active state whether they are moving or not so as to notify the individual (e.g., Japanese Patent Application Laid-Open No. 10-228502).

As a place for problem solving or knowledge creating beyond a barrier of departments or roles in organization's activities in these years, the effectiveness of a place for informal talks has been recognized. Informal talks take place as an incidental situation, for example, an accidental meeting in a corridor, a cafeteria, in front of a vending machine, a smoking room, or the like in a company.

Meanwhile, in a case of a formal dialogue (e.g., a conference or a business discussion) held in a conference room or an interview room with such a place and a time previously arranged, flexibility (voluntary, impromptu characteristics) available in informal discussions is hardly obtained because a purpose of dialogue and the positions of discussing persons are limited.

Many technologies are available to support formal dialogues, but not so many to support informal dialogues.

Accordingly, the present invention has been made in view of the above circumstances and provides a dialogue support system, device, method and program, which retain flexibility of informal dialogues and support to enhance an accidental frequency so as to increase the opportunities of attending to dialogues.

### SUMMARY OF THE INVENTION

To achieve the above-mentioned objective, an aspect of the present invention is a dialogue support system for supporting the occurrence of a dialogue in a place designated as a dialogue place, comprising: a dialogue condition accumulation section for accumulating a dialogue condition containing the designation of a desired situation and the designation of a destination; a situation detection device, which is disposed in the dialogue place, for detecting a situation of the dialogue place; a situation monitoring section for comparing the situation of the dialogue place detected by the situation detection device and the dialogue condition accumulated in the dialogue condition accumulation section to judge whether the detected situation conforms to the dialogue condition; and a notification section for notifying a designated destination that the situation conforming to the dialogue condition has occurred when it is judged by the situation monitoring section that the situation conforms to the dialogue condition.

Another aspect of the present invention is a dialogue support device for supporting the occurrence of a dialogue in a place designated as a dialogue place, comprising: a dialogue condition accumulation section for accumulating a dialogue condition including the designation of a desired situation and the designation of a destination; a situation acquisition section for obtaining a situation of the dialogue place detected by a situation detection device disposed in the dialogue place; a situation monitoring section for comparing the situation of the dialogue place obtained by the situation acquisition section and the dialogue condition accumulated in the dialogue condition accumulation section to judge whether the situation conforms to the dialogue condition; and a notification section for notifying a designated destination that the situation conforming to the dialogue condition has occurred when it is judged by the situation monitoring section that the situation conforms to the dialogue condition.

A still another aspect of the present invention is a dialogue support method for supporting the occurrence of a dialogue in a place designated as a dialogue place, comprising: obtaining a situation of the dialogue place detected by a situation detection device disposed in the dialogue place; comparing the obtained situation and a dialogue condition containing the designation of a desired situation and the designation of a destination; and notifying the occurrence of a situation conforming to the dialogue condition to the destination designated by the dialogue condition when the situation conforms to the dialogue condition.

A still another aspect of the present invention is a dialogue support program for supporting the occurrence of a dialogue in a place designated as a dialogue place, which causes a computer to perform the following: a dialogue condition accumulating process for accumulating a dialogue condition containing the designation of a desired situation and the designation of a destination; a situation acquisition process for obtaining a situation of the dialogue place detected by a situation detection device disposed at the dialogue place; a situation monitoring process for comparing the situation of the dialogue place obtained by the situation acquisition process and the dialogue condition accumulated by the dialogue condition accumulating process to judge whether the situation conforms to the dialogue condition; and a notification process for notifying the designated destination that the situation conforming to the dialogue condition has occurred when it is judged by the situation monitoring process that the situation conforms to the dialogue condition.

According to the present invention, it is configured that a situation of a dialogue place to be detected by the situation detection device disposed in the dialogue place is obtained, the obtained situation is compared with the dialogue condition containing the designation of a desired situation and the designation of a destination, and when the situation conforms to the dialogue condition, notification is made to the destination designated by the dialogue condition that the situation conforming to the dialogue condition has occurred. Thus, a person desiring to have a dialogue can start a dialogue without missing a good chance that a desired dialogue condition is established.

### BRIEF DESCRIPTION OF THE DRAWINGS

Preferred embodiments of the present invention will be described in detail based on the following figures, wherein:

FIG. 1 is a diagram showing a schematic structure of a dialogue support system to which the present invention is applied;

FIG. 2 is a diagram illustrating usage of base stations 5;

FIG. 3 is a block diagram showing a functional structure of a dialogue support system;

FIG. 4 is a diagram showing an example of a screen shown by a dialogue condition input section 21;

FIG. 5 is a flow chart showing a flow of a dialogue condition reception process by a dialogue support device 1;

FIG. 6A, FIG. 6B and FIG. 6C are diagrams showing examples of information collected by a base station control device 3;

FIG. 7 is a diagram showing in time sequence the information shown in FIG. 6A;

FIG. 8 is a flow chart showing a flow of a situation monitoring process by the dialogue support device 1;

FIG. 9 is a flow chart showing a flow of a dialogue condition reception process by the dialogue support device 1;

FIG. 10 is a flow chart showing a flow of a situation monitoring process by the dialogue support device 1;

FIG. 11 is a diagram showing an example of arrangement of devices in a dialogue place to perform a retention process so as to stop a dialogue party in the dialogue place;

FIG. 12 is a flow chart showing a flow of the retention process;

FIG. 13 is a diagram showing an example of a connection configuration of the dialogue support devices, information terminals and base station control devices according to Example 5;

FIG. 14 is a block diagram showing a functional structure of a dialogue support device 1-1;

FIG. 15 is a diagram showing an example of a connection configuration of the dialogue support devices, information terminals and base station control devices according to Example 6;

FIG. 16 is a block diagram showing a functional structure of a dialogue support device 1-3;

FIG. 17 is a flow chart showing a flow of an operation of a dialogue condition generation section 18; and

FIG. 18 is a diagram illustrating an example of using a dialogue support system at an exhibition.

### DESCRIPTION OF THE PREFERRED EMBODIMENTS

Preferred embodiments of a dialogue support system, device, method and program according to the present invention will be described with reference to the accompanying drawings.

The dialogue support system to which the present invention is applied will be described in Example 1, and modified examples and the like of Example 1 will be described in other Examples. The structure of each example can be appropriately combined with the structures of the other Examples.

### EXAMPLE 1

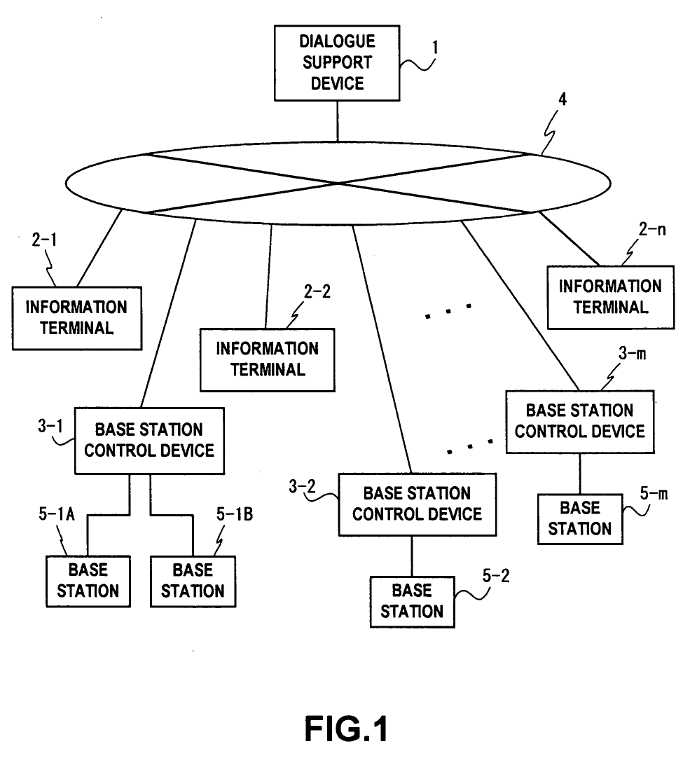

FIG. 1 is a diagram showing a schematic structure of a dialogue support system to which the present invention is applied. As shown in FIG. 1, the dialogue support system is configured by connecting a dialogue support device 1 with plural information terminals 2 (2-1 to 2-n) and plural base station control devices 3 (3-1 to 3-m) through a network 4.

At least one base station 5 (5-1A, 5-1B to 5-m) is connected to the individual base station control devices 3.

The dialogue support device 1 is a device for supporting the occurrence of an informal dialogue, in which dialogue conditions such as a dialogue party, a place, a time and the like are registered, and when a situation conforming to the dialogue conditions occurs, performs an operation to notify a designated destination or the like. The dialogue support device 1 can also be achieved by running a program on a general-purpose computer device, which can be operated as a web server for the information terminals 2.

The information terminals 2 can register the dialogue conditions in the dialogue support device 1, and a general-purpose computer device and a portable terminal can be used. Especially, when the dialogue support device 1 operates as a wave server, the information terminals 2 do not need dedicated software, and any device capable of operating a web browser only can be used as the information terminal 2.

The base station control device 3 controls the base stations 5 and sends a situation and the like about the dialogue party detected by the base stations 5 to the dialogue support device 1.

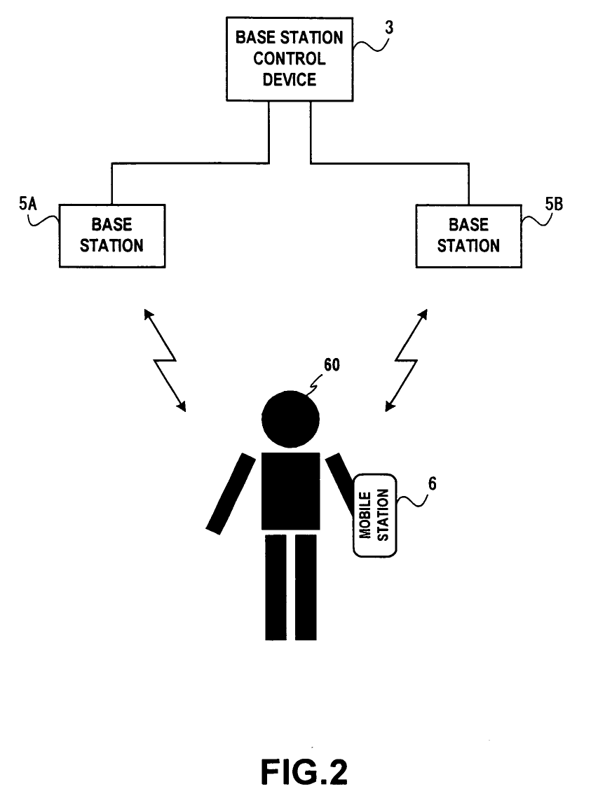

Here, the base station control devices 3 and the base stations 5 will be described. FIG. 2 is a diagram illustrating usage of the base stations 5.

As shown in FIG. 2, the base station 5A and the base station 5B connected to the base station control device 3 detect a mobile station 6 possessed by a person 60. The person 60 is a person, who can be designated as a dialogue party by the dialogue conditions registered in the dialogue support device 1, for example, a member of a given organization when the dialogue support device 1 is used in the organization.

The number of the base stations 5 connected to the base station control device 3 is variable depending on types of the base stations 5 and where they are disposed. The place where the base stations 5 are disposed is a place designated as a dialogue place by the dialogue conditions registered in the dialogue support device 1, such as a lounge, a smoking area or a place of vending machines. The base station control device 3 may be disposed in each dialogue place or may be configured to connect plural base stations 5 disposed in plural dialogue places.

The mobile station 6 is used to check the presence or not of the person 60 having it and detected by the base station 5A and the base station 5B. Therefore, there are appropriate combinations between them. For example, when the mobile station 6 is a portable terminal having a radio communication capability, the base station 5A and the base station 5B have a corresponding communication capability, and when the mobile station 6 is an infrared badge, the base station 5A and the base station 5B become an infrared antenna.

The combination of the base stations 5 and the mobile station 6 is not limited to the above. The person 60 can be identified by a non-contact type RFID (Radio Frequency Identification) reader (corresponding to the base station 5) disposed at a point through which the person 60 enters or leaves the dialogue place and an RFID card (corresponding to the mobile station 6) possessed by the person 60. Besides, a technology of recognizing a facial image or a voice pattern of a person present in a particular place can be used instead of or to complement the combination of the base stations 5 and the mobile station 6.

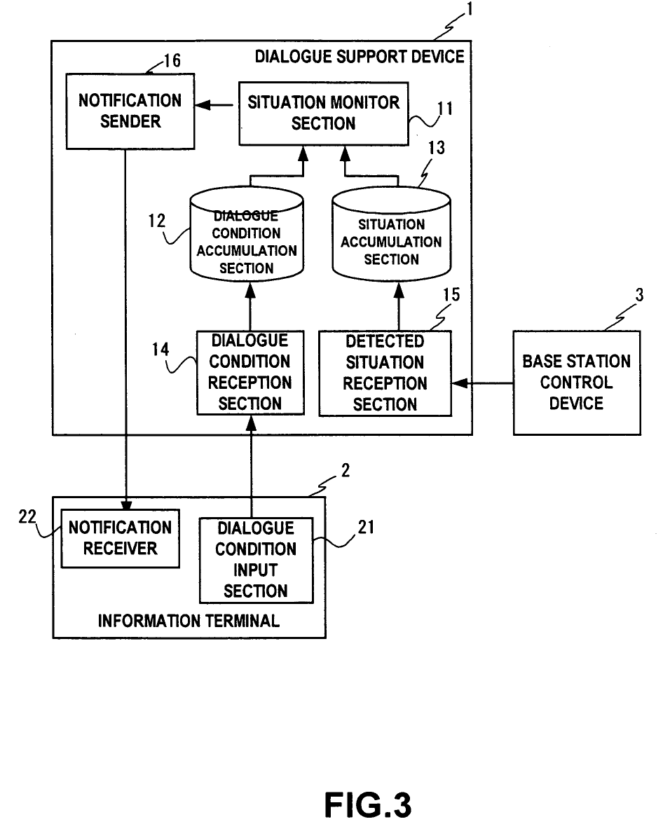

The dialogue support system shown in FIG. 1 will be described in detail. FIG. 3 is a block diagram showing a functional structure of the dialogue support system.

As shown in FIG. 3, the dialogue support device 1 is comprised of a situation monitoring section 11, a dialogue condition accumulation section 12, a situation accumulation section 13, a dialogue condition reception section 14, a detected situation reception section 15 and a notification sender 16. The information terminal 2 is comprised of a dialogue condition input section 21 and a notification receiver 22.

In this configuration, the dialogue conditions are input by a user through the dialogue condition input section 21 of the information terminal 2. The dialogue conditions input through the dialogue condition input section 21 are sent to the dialogue support device 1 and received by the dialogue condition reception section 14 of the dialogue support device 1. The dialogue conditions received by the dialogue condition reception section 14 are accumulated in the dialogue condition accumulation section 12.

Meanwhile, each of the base station control devices 3 sends the situation, such as the presence or not of a dialogue party detected by the connected base station 5, to the dialogue support device 1, and the detected situation reception section 15 of the dialogue support device 1 receives it. The detected situation received by the detected situation reception section 15 is accumulated in the situation accumulation section 13.

The dialogue condition accumulated in the dialogue condition accumulation section 12 and the detected situation accumulated in the situation accumulation section 13 are monitored by the situation monitoring section 11, and when a detected situation conforming to the dialogue condition accumulated in the dialogue condition accumulation section 12 is accumulated in the situation accumulation section 13, the situation monitoring section 11 sends a notice to a destination designated as a dialogue condition. The notice sent by the situation monitoring section 11 is sent to the notification receiver 22 of the information terminal 2 by the notification sender 16.

Subsequently, an operation of the dialogue support system shown in FIG. 3 will be described in detail. First, input and reception of the dialogue condition will be described.

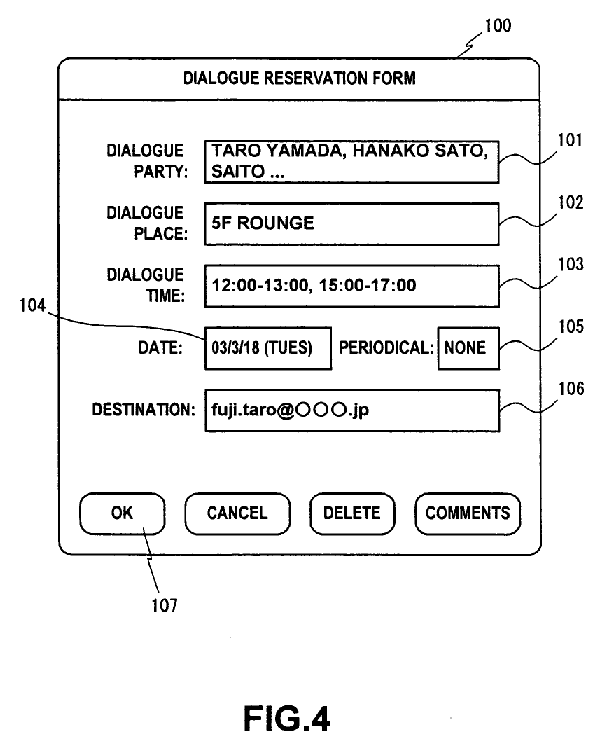

The dialogue condition is input through the dialogue condition input section 21 of the information terminal 2. The dialogue condition input section 21 shows a screen 100 as shown in FIG. 4 on a display (not shown) of the information terminal 2 to urge the user to input the dialogue condition. The screen 100 has substantially the same input items regardless of whether or not the dialogue condition input section 21 is realized by a dedicated program running on the information terminal 2 or information supplied from the dialogue support device 1 is shown by a web browser or the like.

As shown in FIG. 4, the screen 100 has individual input blocks of a dialogue party input box 101, a dialogue place input box 102, a dialogue time input box 103, a date input box 104, a periodical designation input box 105 and a destination input box 106 and also an instruction button such as an OK button 107.

A dialogue party desired by the user is input to the dialogue party input box 101. Information on the dialogue party to be input is information, which can uniquely specify the dialogue party on the side of the dialogue support device 1, and when the name has been registered in the dialogue support device 1, the name can be input directly. Anything other than the name can also be used when it is registered in the dialogue support device 1. Registration of the name or the like in the dialogue support device 1 can be omitted by inputting an ID or the like for specifying the mobile station 6 possessed by the dialogue party.

A dialogue place desired by the user is input to the dialogue place input box 102. Information on the dialogue place to be input may be information which can uniquely specify the dialogue party on the side of the dialogue support device 1 in the same way as in the case of inputting the dialogue party as described above. And, candidate dialogue places may be presented to the user instead of inputting the dialogue place so that the user can select one. A sketch or a map of each dialogue place may be shown on a screen different from the screen 100 when the user selects the dialogue place.

A dialogue time desired by the user is input to the dialogue time input box 103. To input the dialogue time, a time is directly input, but it can also be configured to input words such as “lunch time”, “morning”, “afternoon” or the like. And, to input the dialogue time, a message such as “What is a specified start time?”, “What is a specified end time?”, “Is the next candidate specified?” may be shown on a screen different from the screen 100 so to input a time interactively.

A date when the user desires to have a dialogue is input to the date input box 104. Instead of the date, a calendar or the like may be shown on a screen different from the screen 100 to select a date.

The periodical designation input box 105 is used to input information so to designate whether the dialogue conditions, which are input to the dialogue party input box 101, the dialogue place input box 102 and the dialogue time input box 103, are repeatedly set periodically, and repetition patterns such as “none”, “every day”, “every week”, “every month” and the like can be input. It may also be configured so that candidate alternatives are presented to the user to make the user select the repetition conditions.

The destination input box 106 is a box to which information on the destination is input when a situation conforming to the dialogue conditions input to the dialogue party input box 101, the dialogue place input box 102, the dialogue time input box 103, the date input box 104 and the periodical designation input box 105 occurs. The destination may be the user who has input the dialogue conditions or another person. Information input as the destination is variable depending on means for giving the notice. For example, when e-mail is used to give the notice, a mail address is input the destination input box 106, and when an instant messenger is used to give the notice, an address of the information terminal 2 to be the destination is input. When a telephone is used to give the notice, a telephone number is input to the destination input box 106.

The OK button 107 is used to register the information input to the individual boxes as the dialogue conditions in the dialogue support device 1. When the OK button 107 is depressed (including a selection instruction using a pointing device), the information input to the individual boxes is registered as the dialogue conditions in the dialogue support device 1.

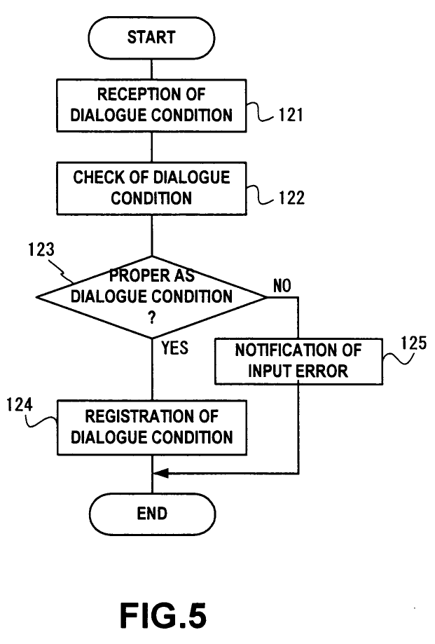

Subsequently, the reception of the dialogue conditions by the dialogue support device 1 will be described. FIG. 5 is a flow chart showing a flow of a dialogue condition reception process by the dialogue support device 1.

When the dialogue support device 1 receives the dialogue conditions from the information terminal 2, the dialogue condition reception section 14 receives the dialogue conditions (step 121). Then, the dialogue condition reception section 14 checks the received dialogue conditions (step 122). To check the dialogue conditions, it is examined whether the dialogue conditions are lacking in information, and the dialogue conditions accumulated in the dialogue condition accumulation section 12 are examined to find if there is a contradiction between the previously registered dialogue conditions and the received dialogue conditions. The contradiction between the dialogue conditions means that, for example, there is a possibility that the previously registered dialogue conditions and the dialogue conditions designating a different dialogue party and dialogue place at the same time are possibly established at the same time.

When it is found as a result of examining the received dialogue conditions that the dialogue conditions are appropriate as the dialogue conditions, namely they have no shortage of information and do not contradict with the previously registered dialogue conditions (YES in step 123), the dialogue condition reception section 14 registers the dialogue conditions in the dialogue condition accumulation section 12 (step 124) and terminates the reception process.

Meanwhile, when it is found as a result of checking the received dialogue conditions that the dialogue conditions are not appropriate as the dialogue conditions (NO in step 123), the dialogue condition reception section 14 notifies an input error to the information terminal 2 (step 125) and terminates the reception process. When the input error is notified to the information terminal 2, the information terminal 2 generally resends the corrected dialogue conditions, and the dialogue condition reception section 14 repeats the same process on the dialogue conditions.

Then, the process from the detection of a situation by the base station 5 to the accumulation in the situation accumulation section 13 will be described. For the base station 5, the above-described various types of devices can be used. Therefore, there is a device capable of detecting all the mobile stations 6 present in the dialogue place by a single base station 5. But, there is also a device which cannot detect the mobile station 6 when there is an obstacle such as a person between the base station 5 and the mobile station 6 and detects the mobile station 6 discontinuously.

When a device, which cannot detect the mobile station 6 if there is an obstacle between the base station 5 and the mobile station 6, is used as the base station 5, plural base stations 5 are disposed in the dialogue place, and the presence of the mobile station 6 is detected based on the detected results by the plural base stations 5, so that the mobile station 6 can be detected without fail. A method of detecting the mobile station 6 with two base station 5 disposed in a prescribed dialogue place will mainly be described below, and a case having one base station 5 disposed will be described appropriately.

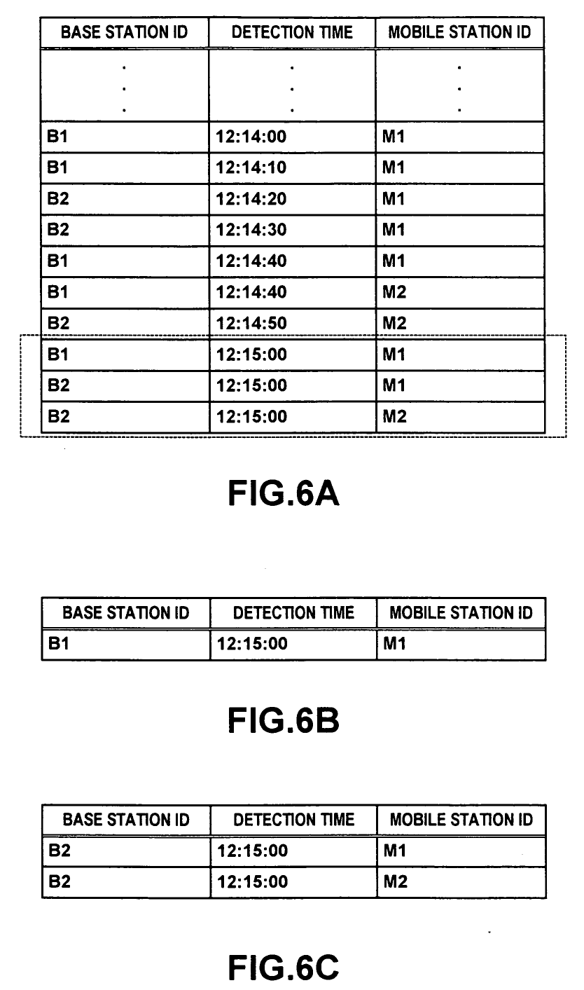

It is assumed that two base stations 5 are disposed in a prescribed dialogue place and IDs B1, B2 are allotted to the base stations 5 respectively. Then, the base station control device 3 to which the base stations 5 are connected collects information as shown in FIG. 6A. The information shown in FIG. 6A indicates the IDs of the mobile station 6 detected by the two base stations 5 and the times of detection. Information within the broken line of FIG. 6A includes information detected by the base station 5 having ID B1 shown in FIG. 6B and information detected by the base station 5 having ID B2 shown in FIG. 6C. Here, the base stations 5 are configured to detect the mobile station 6 every 10 seconds.

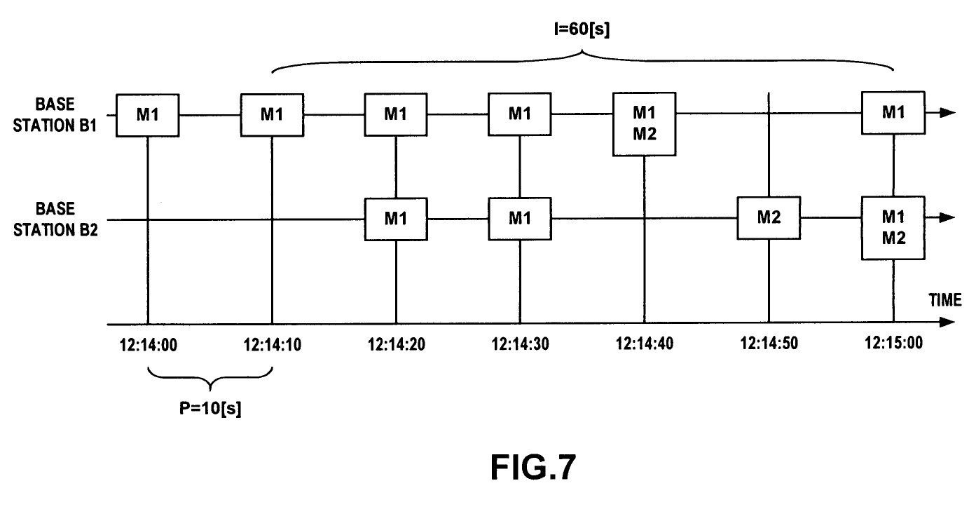

The information shown in FIG. 6A can be shown in time sequence as shown in FIG. 7. It is apparent from FIG. 7 that the base station 5 having ED B1 and the base station 5 having ID B2 detect the mobile station present in the same dialogue place, but the detected results are different.

Therefore, when the presence or not of the mobile station 6 is judged from the detected result by either of the base stations 5, the presence of the mobile station 6 becomes discontinuous, but more accurate judgment can be made by judging the presence of the mobile station 6 based on the union of the detected results by the two base stations.

And, the detection of the mobile station 6 by the base stations 5 detects the mobile station 6 present in the dialogue place at that time, so that the mobile station 6 is naturally detected when a person having the mobile station 6 is in the dialogue place and may also be detected even when the person passes through nearby. When the mobile station 6 possessed by the person merely passing nearby is detected by the base stations 5 and, if the detected results are judged that the mobile station 6 is present in the dialogue place, the dialogue support device 1 notifies that the dialogue condition has been established even if the dialogue condition is not met.

Therefore, for judgment of the presence of the mobile station 6, a criterion is determined to be D. And, when a detection rate of the mobile station 6 detected in a prescribed inspection period W is D or more, it is judged that the mobile station 6 is detected. For example, when the criterion D is 0.5 and the inspection period W is 60 seconds, the presence or not of the mobile station 6 at “12:15:00” shown in FIG. 7 is judged based on the detected results from “12:14:00” to “12:15:00”. And, the mobile station 6 having ID M1 is judged to be “present” because the detection rate is ⅚ indicating D or more, and the mobile station 6 having ID M2 is judged to be “present” because the detection rate is 3/6 indicating D or more.

When the presence of the mobile station 6 is judged from the detected results by the two base stations 5 under the same condition, it is judged from the detected results by the base station 5 having ID B1 that the mobile station 6 having ID M1 is “present” because the detection rate is ⅚ indicating D or more, and the mobile station 6 having ID M2 is “absent” because the detection rate is ⅙ indicating less than D. Similarly, it is judged from the detected results by the base station 5 having ID B2 that the mobile station 6 having D) M1 is “present” because the detection rate is 3/6 indicating D or more, and the mobile station 6 having ID M2 is “absent” because the detection rate is 2/6 indicating less than D. In this case, if only one base station 5 is disposed in the dialogue place, the mobile station 6 having ID M2 is erroneously detected. Therefore, a value of the criterion D is appropriately changed depending on the number of the base stations 5 disposed in the dialogue place.

The base station control device 3 may conduct the process of judging the presence of the mobile station 6 and send the processed result to the dialogue support device 1. But, it may be configured so that the base station control device 3 sends the detected result by the base station 5 to the dialogue support device 1, the detected situation reception section 15 of the dialogue support device 1 judges the presence of the mobile station 6, and the result is accumulated in the situation accumulation section 13. It can also be configured so that the detected result by the base station 5 is accumulated in the situation accumulation section 13, and the situation monitoring section 11 judges the presence of the mobile station 6.

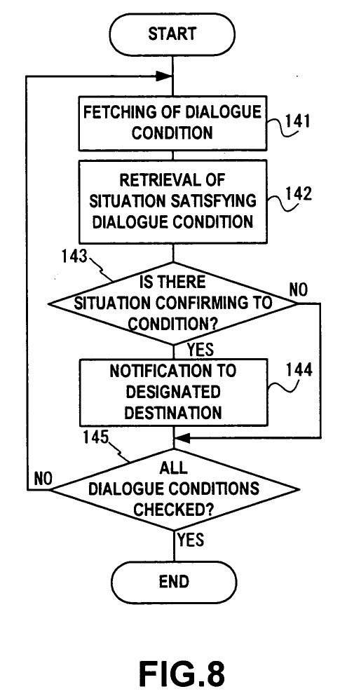

Then, a process of monitoring the situation and giving a notice to the user will be described. FIG. 8 is a flow chart showing a flow of a situation monitoring process by the dialogue support device 1.

In the dialogue support device 1, the situation monitoring section 11 performs periodically a process of monitoring the situation of each dialogue place. The situation monitoring process first retrieves a dialogue condition from the dialogue condition accumulation section 12 (step 141) and searches the situation accumulation section 13 for a situation satisfying the retrieved dialogue condition (step 142). When the situation monitoring section 11 judges the presence of the mobile station 6 as described above, the presence of the mobile station 6 is also judged when the situation accumulation section 13 is searched.

When the search of the situation accumulation section 13 results in the presence of a situation conforming to the dialogue condition (YES in step 143), it is notified to the destination designated by the dialogue condition through the notification sender 16 that the situation conforming to the dialogue condition has occurred (step 144). And, when the search of the situation accumulation section 13 results in the absence of the situation conforming to the dialogue condition (NO in step 143), notification is not provided.

When the above processing results in that the dialogue condition accumulation section 12 has an unprocessed dialogue condition (NO in step 145), the procedure returns to step 141, and the same process is performed according to the unprocessed dialogue condition. And, when the same processing is conducted according to all the dialogue condition accumulated in the dialogue condition accumulation section 12 (YES in step 145), the situation monitoring section 11 terminates the situation management processing.

In addition to the processing described above, the situation monitoring section 11 also performs processing to delete an invalid dialogue condition such as a lapse of the specified date and time among the dialogue condition accumulated in the dialogue condition accumulation section 12.

### EXAMPLE 2

For the dialogue condition reception process by the dialogue support device 1, processing different from that described in Example 1 will be described in Example 2. Processing other than the dialogue condition reception process is the same as that described in Example 1, and its description will be omitted.

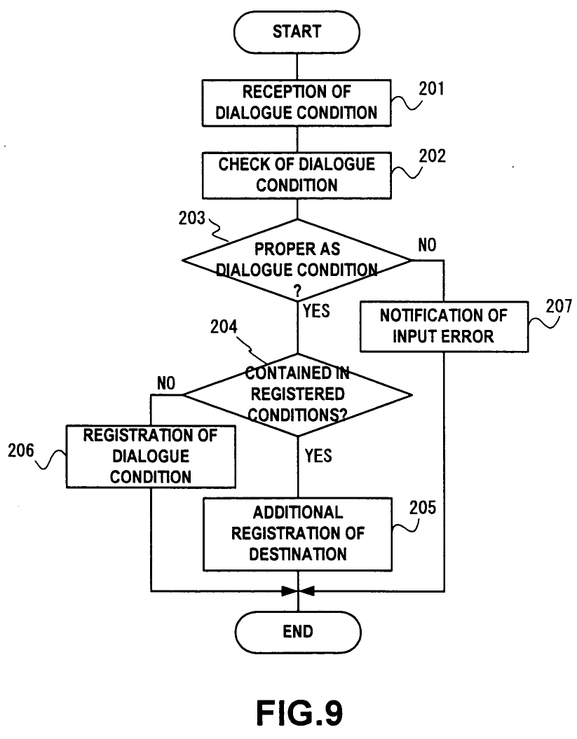

The dialogue condition reception process in Example 2 processes by judging whether the received dialogue condition is contained in the already-registered dialogue condition. FIG. 9 is a flow chart showing a flow of dialogue condition [symbol] reception process by the dialogue support device 1.

When the dialogue support device I receives a dialogue condition from the information terminal 2, the dialogue condition reception section 14 receives the pertinent dialogue condition (step 201). Subsequently, the dialogue condition reception section 14 checks the received dialogue condition (step 202). Checking of the dialogue condition includes an examination on whether the dialogue condition has missing information, an examination on the dialogue conditions accumulated in the dialogue condition accumulation section 12, an examination on a possibility of contradiction between the previously registered dialogue conditions and the received dialogue condition, and an examination on whether the previously registered dialogue conditions includes the received dialogue condition.

When it is found as a result of examinations on the received dialogue condition that the pertinent dialogue condition is appropriate as a dialogue condition, namely it has no missing information or no contradiction with the already registered dialogue conditions (YES in step 203), and information other than the destination is included in the previously registered dialogue conditions (YES in step 204), the dialogue condition reception section 14 additionally registers the destination of the dialogue condition, which is received to the destination of the previously registered dialogue conditions, into the dialogue condition accumulation section 12 (step 205) and terminates the reception process.

When it is found as a result of examining the received dialogue condition that the pertinent dialogue condition is appropriate as a dialogue condition (YES in step 203) but it is not included in the previously registered conditions (NO in step 204), the dialogue condition reception section 14 registers the pertinent dialogue condition in the dialogue condition accumulation section 12 (step 206) and terminates the reception process.

Meanwhile, when it is found as a result of checking the received dialogue condition that the pertinent dialogue condition is not proper as a dialogue condition (NO in step 203), the dialogue condition reception section 14 notifies an input error to the information terminal 2 (step 207) and terminates the reception process. When the input error is notified to the information terminal 2, the information terminal 2 generally resends the corrected dialogue condition, so that the dialogue condition reception section 14 repeats the same process on the pertinent dialogue condition.

### EXAMPLE 3

In Example 3, a situation monitoring process by the dialogue support device 1 different from the process described in Example 1 will be described. The process other than the situation monitoring process is the same as that described in Example 1, and its description is omitted.

In the situation monitoring process in Example 3, when the monitored situation conforms to the registered dialogue condition, the situation of the destination designated by the dialogue condition is checked, and it is decided according to the situation whether a notice is given.

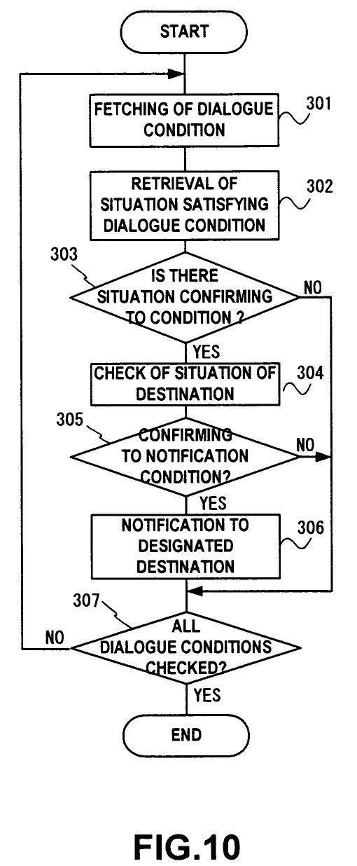

FIG. 10 is a flow chart showing a flow of a situation monitoring process by the dialogue support device 1. In Example 3, a condition for notifying as a dialogue condition to the destination or its exclusion condition can be designated.

In the dialogue support device 1, the situation monitoring section 11 periodically performs a situation monitoring process of each dialogue place. In the situation monitoring process, the dialogue condition is first retrieved from the dialogue condition accumulation section 12 (step 301), and a situation conforming to the retrieved dialogue condition is retrieved from the situation accumulation section 13 (step 302).

When it is found as a result of searching the situation accumulation section 13 that there is a situation conforming to the dialogue condition (YES in step 303), a situation of the destination designated by the dialogue condition is checked (step 304). The destination situation is checked by using information on groupware being used in the pertinent organization or obtaining the existing place of a destination and the like from the other situations accumulated in the situation accumulation section 13. When it is found as a result that the destination situation conforms to the notification condition or does not conform to an exclusion condition (YES in step 305), it is notified to the destination designated by the pertinent dialogue condition through the notification sender 16 that the situation conforming to the dialogue condition has occurred (step 306).

Meanwhile, when the situation of the destination cannot be checked, does not conform to the notification condition or conforms to the exclusion condition (NO in step 305), notification is not conducted. And, when it is found as a result of searching the situation accumulation section 13 that there is no situation conforming to the dialogue condition (NO in step 303), notification is not conducted.

When it is found as a result of the processes described above that there is an unprocessed dialogue condition in the dialogue condition accumulation section 12 (NO in step 307), the procedure returns to the step 301, and the same process is conducted according to the unprocessed dialogue condition. And, after the same process is conducted according to all the dialogue conditions accumulated in the dialogue condition accumulation section 12 (YES in step 307), the situation monitoring section 11 terminates the situation management process.

### EXAMPLE 4

Example 4 is an example of processing to stop a dialogue party in a dialogue place until a notified user moves to the dialogue place when a dialogue condition is established.

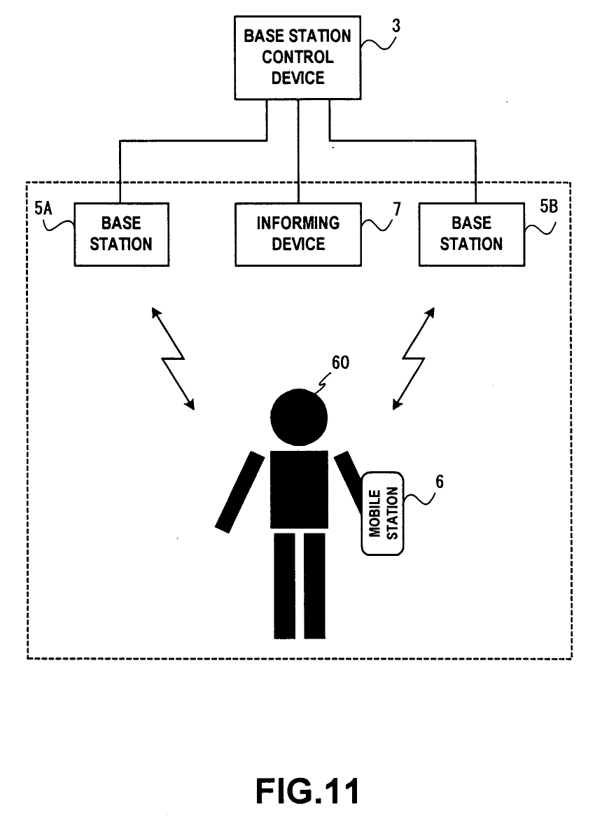

FIG. 11 is a diagram showing a device arrangement example in the dialogue place when a retention process is conducted to stop the dialogue party in the dialogue place. As shown in FIG. 11, a base station 5A, a base station 5B and an informing device 7 are disposed in the dialogue place and connected to the base station control device 3. The area in the broken like in FIG. 11 is the dialogue place.

The base station 5A and the base station 5B detect the mobile station 6 possessed by the person 60 in the same way as in Example 1. When the dialogue condition is established in the dialogue place, it is informed by the informing device 7, so that the dialogue party is stopped in the pertinent dialogue place. The informing device 7 may be a loud speaker or the like to issue a voice or a display or the like to show characters. When the mobile station 6 is of a type capable of producing a voice or displaying upon receiving information from the base station 5A or the like, the mobile station 6 can also be used as the informing device 7.

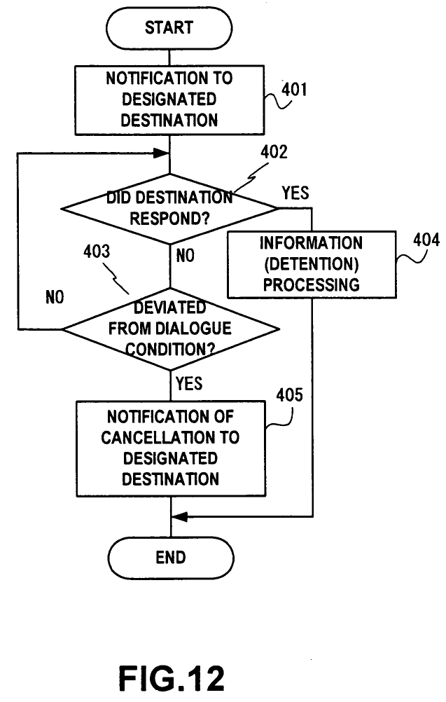

Here, a flow of a retention process will be described. FIG. 12 is a flow chart showing a flow of the retention process.

In this process, when the situation monitoring section 11 judges that there is a situation conforming to the dialogue condition (e.g., the process of Example 1 which becomes YES in step 143 shown in FIG. 8), the situation monitoring section 11 notifies the destination designated by the dialogue condition that the situation conforming to the dialogue condition has occurred (step 401). And, the situation monitoring section 11 waits that the user of the destination responds to the pertinent notification (NO in step 402, and NO in step 403).

Here, when the user of the destination responds to the notification (YES in step 402), it is assumed that the pertinent user has started to move to the dialogue place, and the dialogue support device 1 operates the informing device 7 disposed in the pertinent dialogue place to stop the dialogue party in the dialogue place (step 404) and terminate the process.

When the situation of the pertinent dialogue place deviates from the dialogue condition that the conformity was notified before the user of the destination responds (YES in step 403), the situation monitoring section 11 notifies the user of the destination that the dialogue condition has deviated (step 405) and terminates the process.

In this retention process, when it is possible to detect the movement of the user of the destination, the detection of the movement of the pertinent user can be determined as a condition for informing instead of the process of waiting for the response by the pertinent user.

The retention process described here is performed instead of the process of step 144 for the situation monitoring process in Example 1 (see FIG. 8), but the process shown in FIG. 8 is not stopped while a response from the user is being waited in the pertinent retention process, and they are conducted at the same time.

### EXAMPLE 5

The individual examples described above are configured so that the dialogue support device 1 receives the dialogue conditions from all the information terminals 2 and monitors the situations of all the dialogue places through all the base station control devices 3 (base stations 5), namely they are examples to conduct centralized control. In Example 5, however, an example of conducting decentralized control by plural dialogue support devices will be described.

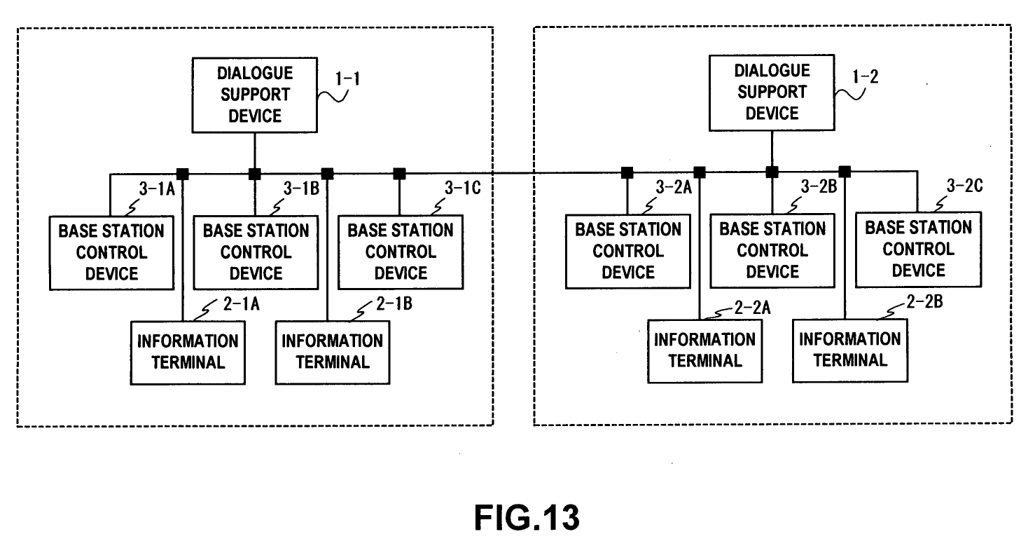

FIG. 13 is a diagram showing an example of a connected configuration of dialogue support devices, information terminals and base station control devices of Example 5. The connection shown in FIG. 13 is logical connection and does not necessarily conform to the connection mode of a network.

According to the connected structure of Example 5 as shown in FIG. 13, a dialogue support device 1-1, a dialogue support device 1-2, an information terminal 2-1A, an information terminal 2-1B, an information terminal 2-2A, an information terminal 2-2B, a base station control device 3-1A, a base station control device 3-1B, a base station control device 3-1C, a base station control device 3-2A, a base station control device 3-2B and a base station control device 3-2C are connected through a network.

In this structure, the dialogue support device 1-1 receives the dialogue conditions from the information terminal 2-1A and the information terminal 2-1B and monitors a situation of the dialogue place according to the detected results by the base station (not shown) connected to each of the base station control device 3-1A, the base station control device 3-1B and the base station control device 3-1C.

And, when the dialogue conditions received from the information terminal 2-1A and the information terminal 2-1B designate a dialogue place corresponding to any of the base station control device 3-2A, the base station control device 3-2B and the base station control device 3-2C, the dialogue support device 1-1 transfers the pertinent dialogue conditions to the dialogue support device 1-2.

Besides, the dialogue support device 1-1 notifies directly to the destination that the situation has conformed to the dialogue condition as a matter of fact when the destination designated by the dialogue conditions is the information terminal 2-1A or the information terminal 2-1B or even when the destination is the information terminal 2-2A or the information terminal 2-2B.

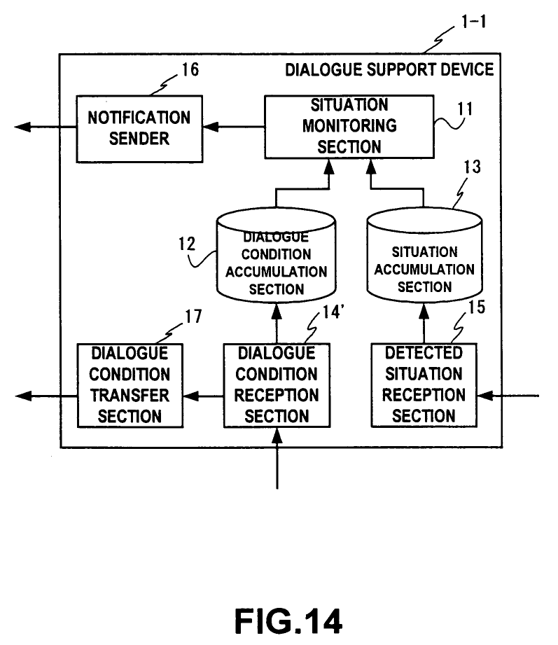

Therefore, the dialogue support device 1-1 has a structure as shown FIG. 14. FIG. 14 is a block diagram showing a functional structure of the dialogue support device 1-1.

As shown in FIG. 14, the dialogue support device 1-1 is comprised of a situation monitoring section 11, a dialogue condition accumulation section 12, a situation accumulation section 13, a dialogue condition reception section 14′, a detected situation reception section 15, a notification sender 16 and a dialogue condition transfer section 17.

In this structure, the situation monitoring section 11, the dialogue condition accumulation section 12, the situation accumulation section 13, the detected situation reception section 15 and the notification sender 16 operate in the same way as in Example 1 (see FIG. 3). When the received dialogue condition shall be accepted by the dialogue support device 1-1, namely it shall be designated to be a place corresponding to any of the base station control device 3-1A, the base station control device 3-1B or the base station control device 3-1C, the dialogue condition reception section 14′ operates in the same way as in Example 1, and when the received dialogue condition shall be accepted by the dialogue support device 1-2, namely it is designated to be a place corresponding to any of the base station control device 3-2A, the base station control device 3-2B or the base station control device 3-2C, the dialogue condition reception section 14′ sends the pertinent dialogue condition to the dialogue support device 1-2 through the dialogue condition transfer section 17. The dialogue condition transfer section 17 operates to transfer the dialogue condition to the dialogue support device 1-2.

Similarly, the dialogue support device 1-2 receives the dialogue conditions from the information terminal 2-2A and the information terminal 2-2B and monitors a situation of the dialogue place according to the detected results by a base station (not shown) connected to the base station control device 3-2A, the base station control device 3-2B and the base station control device 3-2C, and when the dialogue condition received from the information terminal 2-2A or the information terminal 2-2B designates a dialogue place corresponding to any of the base station control device 3-1A, the base station control device 3-1B or the base station control device 3-1C, the pertinent dialogue condition is transferred to the dialogue support device 1-2. The dialogue support device 1-2 notifies directly to the destination that the situation has conformed to the dialogue condition as a matter of fact when the destination designated by the dialogue condition is the information terminal 2-2A or the information terminal 2-2B and even when the destination is the information terminal 2-1A or the information terminal 2-1B. The structure of the dialogue support device 1-2 is the same as that of the dialogue support device 1-1, and its description is omitted.

The use of two dialogue support devices was described above, but it is also possible to use three or more dialogue support devices. In that case, the dialogue condition reception section 14′ decides a forwarding destination to transfer the dialogue condition. It is also possible to configure so to transfer the dialogue condition like a bucket brigade without allowing the dialogue condition reception section 14′ decide the forwarding destination of the dialogue condition.

### EXAMPLE 6

Example 6, which is an example of conducting decentralized control by plural dialogue support devices and different from Example 5, will be described.

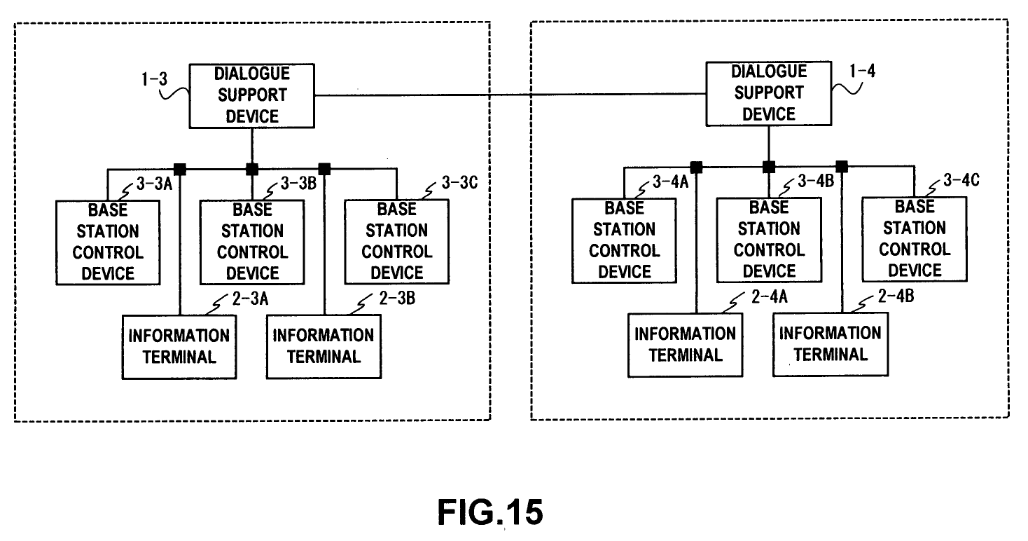

FIG. 15 is a diagram showing an example of a connected configuration of the dialogue support devices, information terminals and base station control devices according to Example 6. Connection shown in FIG. 15 is logical connection and does not necessarily conform to the connection mode of a network.

According to the connected structure of Example 6 as shown in FIG. 15, a dialogue support device 1-3 and a dialogue support device 14 are mutually connected. An information terminal 2-3A, an information terminal 2-3B, a base station control device 3-3A, a base station control device 3-3B and a base station control device 3-3C are connected to the dialogue support device 1-3, and an information terminal 2-4A, an information terminal 2-4B, a base station control device 3-4A, a base station control device 3-4B and a base station control device 3-4C are connected to the dialogue support device 1-4.

In this structure, the dialogue support device 1-3 receives the dialogue conditions from the information terminal 2-3A and the information terminal 2-3B and monitors a situation of the dialogue place according to the detected result by a base station (not shown) which is connected to each of the base station control device 3-3A, the base station control device 3-3B and the base station control device 3-3C.

And, when the dialogue conditions received from the information terminal 2-3A and the information terminal 2-3B designate a dialogue place corresponding to any of the base station control device 34A, the base station control device 3-4B or the base station control device 3-4C, the dialogue support device 1-3 generates a new dialogue condition having the dialogue support device 1-3 as a destination and transfers the generated dialogue condition to the dialogue support device 1-4. And, when a notice indicating the conformity to the pertinent dialogue condition is received from the dialogue support device 1-4, the dialogue support device 1-3 manages it as a situation of the dialogue place and notifies a designated destination according to the pertinent situation.

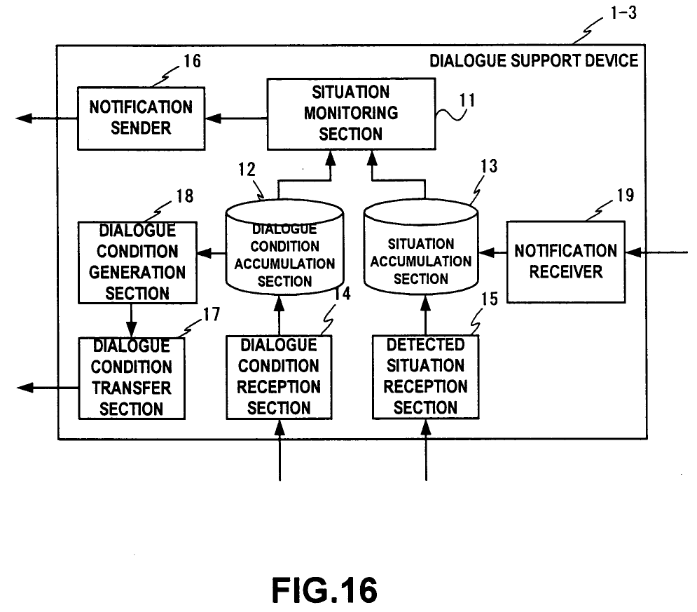

Therefore, the dialogue support device 1-3 has the structure as shown FIG. 16. FIG. 16 is a block diagram showing a functional structure of the dialogue support device 1-3.

As shown in FIG. 16, the dialogue support device 1-3 is comprised of a situation monitoring section 11, a dialogue condition accumulation section 12, a situation accumulation section 13, a dialogue condition reception section 14, a detected situation reception section 15, a notification sender 16, a dialogue condition transfer section 17, a dialogue condition generation section 18 and a notification receiver 19.

In this structure, the situation monitoring section 11, the dialogue condition accumulation section 12, the situation accumulation section 13, the dialogue condition reception section 14, the detected situation reception section 15 and the notification sender 16 operate in the same way as in Example 1 (see FIG. 3). Among the dialogue conditions accumulated in the dialogue condition accumulation section 12, the dialogue condition generation section 18 produces a dialogue condition having the destination changed to the dialogue support device 1-3 based on the designated dialogue place which is not controlled by the dialogue support device 1-3. If possible, plural dialogue conditions may be integrated into one dialogue condition. The dialogue condition transfer section 17 transfers the dialogue condition produced by the dialogue condition generation section 18 to the dialogue support device 1-4. Upon receiving a notification from the dialogue support device 14 that the situation has conformed to the dialogue condition, the notification receiver 19 accumulates it as a situation in the situation accumulation section 13.

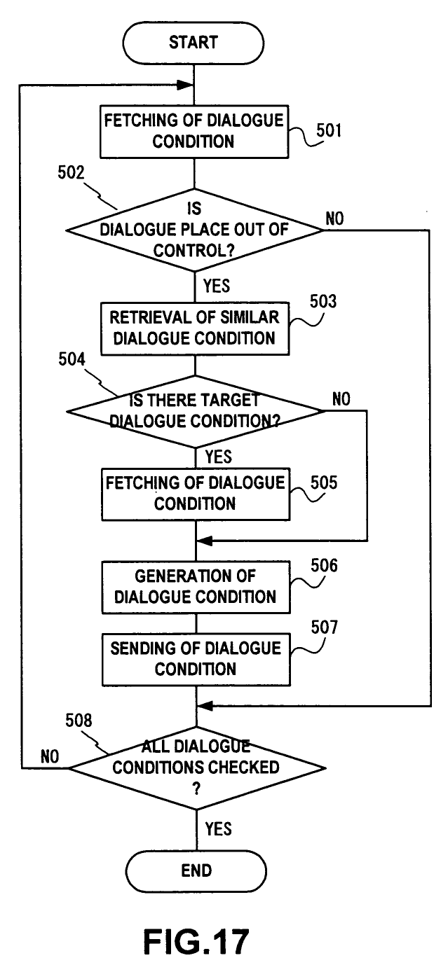

Here, an operation of the dialogue condition generation section 18 will be described. FIG. 17 is a flow chart showing a flow of the operation of the dialogue condition generation section 18.

The dialogue condition generation section 18 first retrieves a dialogue condition from the dialogue condition accumulation section 12 (step 501). When the dialogue place of the retrieved dialogue condition is a place not controlled by the dialogue support device 1-3 (YES in step 502), a similar dialogue condition, e.g., a dialogue condition or the like having the same dialogue place and dialogue party, is retrieved from the dialogue condition accumulation section 12 (step 503). When it is found by retrieving that there is the similar dialogue condition (YES in step 504), the pertinent dialogue condition is taken out (step 505).

And, a dialogue condition having the dialogue support device 1-3 as a destination is produced (step 506), and the produced dialogue condition is sent to the dialogue support device 14 through the dialogue condition transfer section 17 (step 507).

When it is found as a result of the above processes that the dialogue condition accumulation section 12 has an unprocessed dialogue condition (NO in step 508), the procedure returns to step 501, and the same process is conducted according to the unprocessed dialogue condition. And, the same process is conducted according to all the dialogue conditions accumulated in the dialogue condition accumulation section 12 (YES in step 508), and the dialogue condition generation section 18 terminates the process. The dialogue condition generation section 18 periodically conducts the processes described above.

Similarly, the dialogue support device 1-4 receives the dialogue conditions from the information terminal 2-4A and the information terminal 2-4B and monitors a situation of the dialogue place according to the detected results by a base station (not shown) connected to the base station control device 3-4A, the base station control device 3-4B and the base station control device 3-4C. When the dialogue conditions received from the information terminal 24A and the information terminal 2-4B designate a dialogue place corresponding to any of the base station control device 3-3A, the base station control device 3-3B or the base station control device 3-3C, the dialogue support device 1-4 produces a new dialogue condition having the dialogue support device 1-4 as a destination and transfers the produced dialogue condition to the dialogue support device 1-3. And, upon receiving a notice of the conformity to the pertinent dialogue condition from the dialogue support device 1-3, the dialogue support device 14 manages it as a situation of the dialogue place and notifies the designated destination according to the pertinent situation. The dialogue support device 14 has the same structure as the dialogue support device 1-3, so that its description is omitted.

The use of two dialogue support devices was described above, but three or more dialogue support devices can also be used. In that case, the dialogue condition generation section 18 transfers the dialogue condition to a dialogue condition support device corresponding to the dialogue place.

### EXAMPLE 7

In the Examples described above, the dialogue support system was used to support daily dialogues in the organization or the like, but the dialogue support system to which the invention is applied can also be used for other uses. In Example 7, as an example of a different use, use of the dialogue support system to support a dialogue at an exhibition will be described.

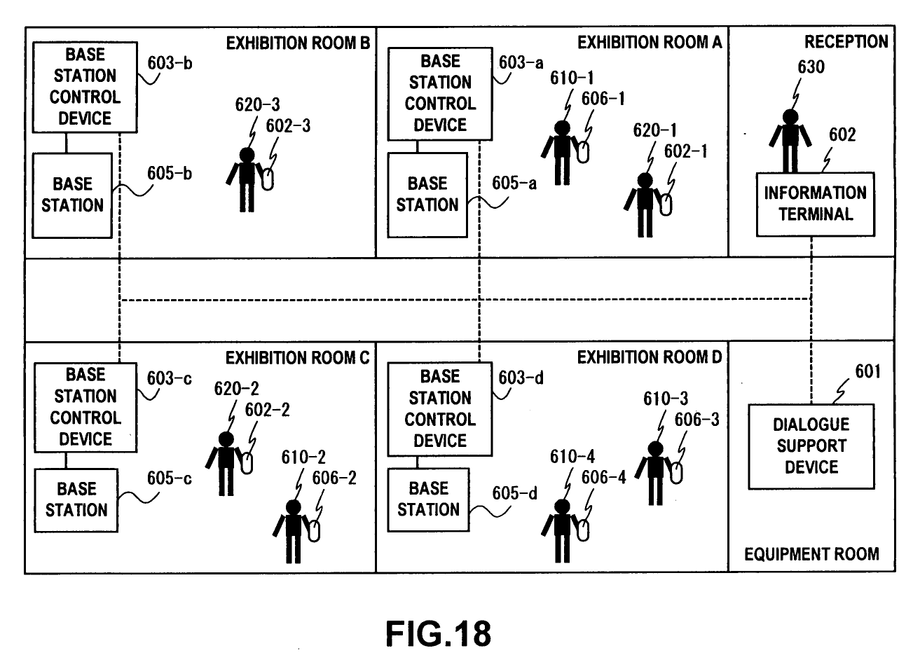

FIG. 18 is a diagram illustrating an example of use of the dialogue support system at the exhibition. As shown in FIG. 18, an exhibition site has a dialogue support device 601 disposed in an equipment room and an information terminal 602 disposed at a reception. A base station control device 603-a and a base station 605-a, a base station control device 603-b and a base station 605-b, a base station control device 603-c and a base station 605-c, and a base station control device 603-d and a base station 605-d are respectively disposed in an exhibition room A, an exhibition room B, an exhibition room C and an exhibition room D.

And, the dialogue support device 601, the information terminal 602, the base station control device 603-a, the base station control device 603-b, the base station control device 603-c and the base station control device 603-d are respectively connected through a network. The broken lines in FIG. 18 indicate that the dialogue support device 601 and the like are connected through the network. The dialogue support device 601 may be disposed anywhere if it can be connected through the network.

The dialogue support device 601 and the information terminal 602 correspond to the dialogue support device 1 and the information terminal 602 described in Example 1 and the like, and the base station control device 603-a and the base station 605-a, the base station control device 603-b and the base station 605-b, the base station control device 603-c and the base station 605-c, and the base station control device 603-d and the base station 605-d respectively correspond to the base station control device 3 and the base station 5 described in Example 1 and the like.

At the exhibition site, visitors (customers) have a mobile station, responsible persons for the site have an information terminal, and they move in the individual exhibition rooms. In the example of FIG. 18, a visitor 610-1, a visitor 610-2, a visitor 610-3 and a visitor 610-4 have a mobile station 606-1, a mobile station 606-2, a mobile station 606-3 and a mobile station 606-4, respectively. And, a responsible person 620-1 for the site, a responsible person 620-2 for the site and a responsible person 620-3 for the site have an information terminal 602-1, an information terminal 602-2 and an information terminal 602-3.

And, the mobile stations possessed by the visitors are lent to the visitors when they are permitted their entrance, and information on the visitors is input through the information terminal 602 by a receptionist 630.

In the configuration described above, the dialogue support device 601 is used to support the occurrence of a dialogue between the visitors and the responsible persons for the site and supports the occurrence of a dialogue in various situations according to the dialogue conditions registered in the dialogue support device 601. The dialogue conditions in this case may be registered previously in the dialogue support device 601 or the receptionist 630 may register them through the information terminal 602. A responsible person for the site, for example, the responsible person 620-1 for the site may register the dialogue conditions using the information terminal 620-1 possessed by him or her.

Here, some examples of the occurrence of a dialogue being supported by the dialogue support device 601 and a dialogue condition at that time will be described.

A first example designates a dialogue place and a staying time in that place as dialogue conditions. For example, “If someone stays in the exhibition room A for 30 minutes or more, it is notified to the responsible person 620-1 for the exhibition room A.” is registered as a dialogue condition. This dialogue condition determines that a visitor staying in a specified place for a prescribed time or more can be judged as having an interest in the exhibition at that site.

In this case, when the presence of the visitor 610-1 is continuously detected by the base station 605-a for 30 minutes or more, it is notified to the information terminal 602-1 possessed by the responsible person 620-1 for the site, and the responsible person 620-1 for the site, who has checked the notice, can rush to the exhibition room A to explain about the exhibited commodities or the like to the visitor 610-1. Thus, a dialogue is held between the visitor 610 who may be interested in the pertinent commodity or the like and the responsible person 620-1 for the site.

Another example designates a dialogue party and a dialogue place as a dialogue condition. For example, “The movement of a person of company A into the exhibition room C is notified to the responsible person 620-2 for the site.” is registered as a dialogue condition. This dialogue condition is determined when a particular commodity is desirably sold to a particular customer, or the like.

In this case, when the presence of the visitor 610-2 of company A is detected by the base station 605-c, it is notified to the information terminal 602-2 possessed by the responsible person 620-2 for the site, the responsible person 620-2 for the site having checked the notice can rush to the exhibition room C to sell the exhibited commodities or the like to the visitor 610-2.

Besides, another example designates a dialogue party and a dialogue place as a dialogue condition. For example, “The movement of a person of company B into the exhibition room D is notified to the responsible person 620-3 for the site, but the notification shall not be given if a person of company C is present in the exhibition room D” is registered as a dialogue condition. This dialogue condition is determined to sell a particular commodity to a particular customer, but when there is a customer competitive to the pertinent customer is present nearby, it is desired to refrain from selling the commodity.

In this case, even when the presence of the visitor 610-3 who is a person from company B is detected by the base station 605-d, a notification is not sent to the information terminal 602-3 possessed by the responsible person 620-3 for the site because the base station 605-d also detects the presence of the visitor 610-4 who is a person from company C. But, when the visitor 6104 moves to another place, the situation conforms to the registered dialogue condition, then the notification is sent to the information terminal 602-3.

To use the dialogue support system at an exhibition site, a variety of dialogue conditions can be set other than those described above. And, the dialogue support system can also be used anywhere other than the exhibition sites.

1. A dialogue support system for supporting the occurrence of a dialogue in a place designated as a dialogue place, comprising:
a dialogue condition accumulation section for accumulating a dialogue condition containing the designation of a desired situation and the designation of a destination;
a situation detection device, which is disposed in the dialogue place, for detecting a situation of the dialogue place;
a situation monitoring section for comparing the situation of the dialogue place detected by the situation detection device and the dialogue condition accumulated in the dialogue condition accumulation section to judge whether the detected situation conforms to the dialogue condition; and
a notification section for notifying a designated destination that the situation conforming to the dialogue condition has occurred when it is judged by the situation monitoring section that the situation conforms to the dialogue condition.

2. The dialogue support system according to claim 1, further comprising:
a dialogue condition registration section for registering a dialogue condition, wherein:
the dialogue condition registration section receives the designation of a dialogue place and registers a dialogue condition containing the received dialogue place in the dialogue condition accumulation section.

3. The dialogue support system according to claim 1, further comprising:
a dialogue condition registration section for registering a dialogue condition, wherein:
the dialogue condition registration section receives the designation of a dialogue party and registers a dialogue condition containing the received dialogue party in the dialogue condition accumulation section.

4. The dialogue support system according to claim 1, wherein:
the situation detection device is provided with:
a mobile unit detection section for detecting a mobile unit possessed by a person who can be a dialogue party; and
a presence judgment section for judging the presence of the dialogue party according to the detected result by the mobile unit detection section.

5. The dialogue support system according to claim 1, further comprising:
a destination status judgment section for judging a status of the destination, wherein:
the notification section notifies the destination that a situation conforming to the dialogue condition has occurred, provided that the status of the destination judged by the destination status judgment section conforms to a predetermined status.

6. The dialogue support system according to claim 1, further comprising:
an informing device which is disposed in the dialogue place and informs the conformity to the dialogue condition when the conformity of the situation to the dialogue condition is judged by the situation monitoring section.

7. The dialogue support system according to claim 6, further comprising:
a response reception section for receiving a response to the notification from the notification section, wherein:
the informing device informs the conformity to the dialogue condition, provided that the response reception section has received the response to the notification.

8. The dialogue support system according to claim 6, further comprising:
a movement detection section for detecting that a person at the destination has moved, wherein:
the informing device informs the conformity to the dialogue condition, provided that the movement of the person at the destination is detected by the movement detection section.

9. A dialogue support device for supporting the occurrence of a dialogue in a place designated as a dialogue place, comprising:
a dialogue condition accumulation section for accumulating a dialogue condition including the designation of a desired situation and the designation of a destination;
a situation acquisition section for obtaining a situation of the dialogue place detected by a situation detection device disposed in the dialogue place;
a situation monitoring section for comparing the situation of the dialogue place obtained by the situation acquisition section and the dialogue condition accumulated in the dialogue condition accumulation section to judge whether the situation conforms to the dialogue condition; and
a notification section for notifying a designated destination that the situation conforming to the dialogue condition has occurred when it is judged by the situation monitoring section that the situation conforms to the dialogue condition.

10. The dialogue support device according to claim 9, further comprising:
a dialogue condition reception section for receiving the registration of a dialogue condition, wherein:
the dialogue condition reception section receives the dialogue condition containing the designation of a dialogue place and registers the received dialogue condition in the dialogue condition accumulation section.

11. The dialogue support device according to claim 9, further comprising:
a dialogue condition reception section for receiving the registration of a dialogue condition, wherein:
the dialogue condition reception section receives the dialogue condition containing the designation of a dialogue party and registers the received dialogue condition in the dialogue condition accumulation section.

12. The dialogue support device according to claim 9, further comprising:
a destination status acquisition section for obtaining a status of a person corresponding to the destination, wherein:
the notification section notifies the destination that a situation conforming to the dialogue condition has occurred, provided that the status of the person obtained by the destination status acquisition section conforms to a predetermined status.

13. The dialogue support device according to claim 9, further comprising:
a standby instruction informing section for informing a standby instruction to the dialogue party present in the dialogue place via an informing device disposed in the dialogue place when it is judged by the situation monitoring section that the situation conforms to the dialogue condition.

14. The dialogue support device according to claim 13, further comprising:
a response reception section for receiving a response to the notification by the notification section, wherein:
the standby instruction informing section informs the standby instruction, provided that the response reception section has received the response to the notification.

15. The dialogue support device according to claim 13, further comprising:
a movement information acquisition section for obtaining a detected result by a movement detection section for detecting the movement of a person at the destination, wherein:
the informing device informs the standby instruction according to the detected result obtained by the movement information acquisition section, provided that the person at the destination has moved.

16. The dialogue support device according to claim 9, further comprising:
a situation accumulation section for accumulating the situation obtained by the situation acquisition section, wherein:
the situation monitoring section compares the situation accumulated in the situation accumulation section and the dialogue condition accumulated in the dialogue condition accumulation section.

17. The dialogue support device according to claim 16, wherein:
the notification section notifies the judged result as a situation of a corresponding dialogue place to a different dialogue support device when it is judged by the situation monitoring section that the situation conforms to the dialogue condition.

18. The dialogue support device according to claim 17, further comprising:
a situation registration section for accumulating in the situation accumulation section the situation notified by the different dialogue support device as a situation of the dialogue place managed by the different dialogue support device.

19. A dialogue support method for supporting the occurrence of a dialogue in a place designated as a dialogue place, comprising:
obtaining a situation of the dialogue place detected by a situation detection device disposed in the dialogue place;
comparing the obtained situation and a dialogue condition containing the designation of a desired situation and the designation of a destination; and
notifying the occurrence of a situation conforming to the dialogue condition to the destination designated by the dialogue condition when the situation conforms to the dialogue condition.

20. The dialogue support method according to claim 19, wherein the dialogue condition contains the designation of a dialogue place.

21. The dialogue support method according to claim 19, wherein the dialogue condition contains the designation of a dialogue party.

22. The dialogue support method according to claim 19, wherein the detected result of a mobile unit possessed by a person who can be a dialogue party is obtained from the situation detection device, the presence of the dialogue party is judged according to the obtained detected result, and the judged result is compared as a situation of the dialogue place with the dialogue condition.

23. The dialogue support method according to claim 19, wherein a status of the destination is judged, and the occurrence of a situation conforming to the dialogue condition is notified to the destination, provided that the judged status of the destination conforms to a prescribed status.

24. The dialogue support method according to claim 19, wherein the conformity to the dialogue condition is informed to a dialogue place corresponding to the dialogue condition when it is judged that the situation conforms to the dialogue condition.

25. The dialogue support method according to claim 24, wherein the conformity to the dialogue condition is informed, provided that there is a response to the notification.

26. The dialogue support method according to claim 24, wherein the movement of a person at the destination is detected, and the conformity to the dialogue condition is informed, provided that the movement of the person is detected.

27. A dialogue support program for supporting the occurrence of a dialogue in a place designated as a dialogue place, which causes a computer to perform the following:
a dialogue condition accumulating process for accumulating a dialogue condition containing the designation of a desired situation and the designation of a destination;
a situation acquisition process for obtaining a situation of the dialogue place detected by situation detection means disposed at the dialogue place;
a situation monitoring process for comparing the situation of the dialogue place obtained by the situation acquisition process and the dialogue condition accumulated by the dialogue condition accumulating process to judge whether the situation conforms to the dialogue condition; and
a notification process for notifying the designated destination that the situation conforming to the dialogue condition has occurred when it is judged by the situation monitoring process that the situation conforms to the dialogue condition.

28. The dialogue support program according to claim 27, further causing the computer to perform a dialogue condition reception process for receiving the registration of the dialogue condition, wherein:
the dialogue condition reception process receives a dialogue condition containing the designation of a dialogue place, and the received dialogue condition is registered by the dialogue condition accumulating process.

29. The dialogue support program according to claim 27, further causing the computer to perform a dialogue condition reception process for receiving the registration of a dialogue condition, wherein:
the dialogue condition reception process receives a dialogue condition containing the designation of a dialogue party, and the received dialogue condition is registered by the dialogue condition accumulating process.

30. The dialogue support program according to claim 27, further causing the computer to perform a destination condition acquisition process for obtaining a status of a person corresponding to the destination, wherein:
the notification process notifies the destination that a situation conforming to the dialogue condition has occurred, provided that the status of the person obtained by the destination condition acquisition process conforms to a predetermined status.

31. The dialogue support program according to claim 27, further causing the computer to perform a standby instruction informing process for informing a standby instruction to a dialogue party present in the dialogue place via informing means disposed in the dialogue place when it is judged by the situation monitoring process that the situation conforms to the dialogue condition.

32. The dialogue support program according to claim 31, further causing the computer to perform a response reception process for receiving a response to the notification by the notification process, wherein:
the standby instruction informing process informs the standby instruction, provided that the response reception process has received the response to the notification.

33. The dialogue support program according to claim 31, further causing the computer to perform a movement information acquisition process for obtaining the detected result by movement detection means for detecting the movement of a person at the destination, wherein:
the informing process informs the standby instruction according to the detected result obtained by the movement information acquisition process, provided that the person at the destination has moved.

34. The dialogue support program according to claim 27, further causing the computer to perform a situation accumulating process for accumulating a situation obtained by the situation acquisition process, wherein:
the situation monitoring process compares the situation accumulated by the situation accumulating process and the dialogue condition accumulated by the dialogue condition accumulating process.

35. The dialogue support program according to claim 34, wherein:
the notification process contains a process to notify the judged result as a situation of a corresponding dialogue place to another dialogue support device when it is judged by the situation monitoring process that the situation conforms to the dialogue condition.

36. The dialogue support program according to claim 35, wherein:
the situation accumulating process contains a process for accumulating the situation notified from the different dialogue support device as a situation of the dialogue place managed by the different dialogue support device.
